(19) United States
(12) Patent Application Publication
(10) Pub. No.: US 2019/0302982 A1
(43) Pub. Date: Oct. 3, 2019

(54) DISPLAY DEVICE

(71) Applicant: KYOCERA Document Solutions Inc., Osaka (JP)

(72) Inventors: Kosuke TAKI, Osaka-shi (JP); Yoichi HIRANUMA, Osaka-shi (JP); Fumiya SAKASHITA, Osaka-shi (JP); Shoichi SAKAGUCHI, Osaka-shi (JP); Shohei FUJIWARA, Osaka-shi (JP)

(73) Assignee: KYOCERA Document Solutions Inc., Osaka (JP)

(21) Appl. No.: 16/365,857

(22) Filed: Mar. 27, 2019

(30) Foreign Application Priority Data
Mar. 29, 2018 (JP) 2018-063968

(51) Int. Cl. G06F 3/0488; G06F 3/041; G06F 3/0484

(52) U.S. Cl. CPC G06F 3/0488; G06F 3/04847; G06F 3/0416

(57) ABSTRACT

A display device includes a display section, an assignment section, a setting section, and a detection section. The detection section specifies a specific candidate selection range among candidate selection ranges and detects an operation to switch between setting and non-setting of selected range setting by the setting section for the specific candidate selection range. In a situation in which the detection section detects a first operation to change the selected range setting for the specific candidate selection range and then detects a second operation performed in a specific direction from the specific candidate selection range, the setting section changes the selected range setting for the specific candidate selection range and changes the selected range setting for a candidate selection range located in the specific direction from the specific candidate selection range to the same setting as that set for the specific candidate selection range.

### INCORPORATION BY REFERENCE

The present application claims priority under 35 U.S.C. § 119 to Japanese Patent Application No. 2018-063968, filed on Mar. 29, 2018. The contents of this application are incorporated herein by reference in their entirety.

### BACKGROUND

The present disclosure relates to a display device.

In recent years, more monitoring systems have been introduced for crime deterrent, accident prevention, and the like. In particular, a number of monitoring systems are installed in a facility accessible by unknown individuals, such as a hotel, a commercial building, a convenience store, a financial institution, an expressway, and a railroad. A monitoring system captures images of a monitoring target person or a monitoring target vehicle with a camera and transmits captured image data generated through the image capture to a monitoring center such as an administrative office or a security office. Monitoring personnel monitors the captured images.

However, the images captured by the monitoring system may include a window of a general house or anything related to personal information, raising concerns about invasion of privacy. To deal with such concerns, a known camera system acquires an image using a camera and displays the acquired image on a display device with a mask region on the displayed picture.

### SUMMARY

A display device according to an aspect of the present disclosure includes a display section, an assignment section, a setting section, and a detection section. The display section displays an image. The assignment section assigns a plurality of candidate selection ranges to the image. The setting section performs selected range setting to set any of the candidate selection ranges to each be a selected range. The detection section detects an operation to switch between setting and non-setting of the selected range setting for a selected candidate selection range selected from among the candidate selection ranges by the setting section. In a situation in which the detection section detects a first operation to change the selected range setting for a specific candidate selection range among the candidate selection ranges and then detects a second operation performed in a specific direction from the specific candidate selection range, the setting section changes the selected range setting for the specific candidate selection range and changes the selected range setting for a candidate selection range located in the specific direction from the specific candidate selection range among the candidate selection ranges to the same setting as that set for the specific candidate selection range.

### BRIEF DESCRIPTION OF THE DRAWINGS

FIG. 1 is a block diagram of a display device according to an embodiment of the present disclosure.

FIG. 2 is a schematic diagram illustrating a display section that displays an image in the display device according to the embodiment.

FIG. 3 is a schematic diagram illustrating the display section displaying an image to which a plurality of candidate selection ranges are assigned in the display device according to the embodiment.

FIG. 4 is a schematic diagram illustrating the display section displaying an image in which a selected range is set in the display device according to the embodiment.

FIG. 5A is a schematic diagram illustrating the display device subjected to a first operation according to the embodiment.

FIG. 5B is a schematic diagram illustrating the display device subjected to a second operation according to the embodiment.

FIG. 6A is a schematic diagram illustrating the display device subjected to the first operation according to the embodiment.

FIG. 6B is a schematic diagram illustrating the display device subjected to the second operation according to the embodiment.

FIG. 7A is a schematic diagram illustrating the display device subjected to the first operation according to the embodiment.

FIG. 7B is a schematic diagram illustrating the display device subjected to the second operation according to the embodiment.

FIG. 8A is a schematic diagram illustrating the display device subjected to a given operation as the first operation according to the embodiment.

FIG. 8B is a schematic diagram illustrating the display device subjected to another operation as the first operation according to the embodiment.

FIG. 9A is a schematic diagram illustrating the display device subjected to the first operation according to the embodiment.

FIG. 9B is a schematic diagram illustrating the display device subjected to the second operation according to the embodiment.

FIG. 10A is a schematic diagram illustrating the display device subjected to the first operation according to the embodiment.

FIG. 10B is a schematic diagram illustrating the display device subjected to the second operation according to the embodiment.

FIG. 11A is a schematic diagram illustrating the display device before a third operation is performed according to the embodiment.

FIG. 11B is a schematic diagram illustrating the display device in the middle of the third operation being performed according to the embodiment.

FIG. 11C is a schematic diagram illustrating the display device after the third operation is performed according to the embodiment.

FIG. 12 is a flowchart depicting candidate selection range assignment and operation setting in the display device according to the embodiment.

FIG. 13 is a flowchart depicting selected range setting in the display device of the embodiment.

FIG. 14 is a block diagram of a monitoring system including the display device according to the embodiment.

### DETAILED DESCRIPTION

The following describes a display device according to an embodiment of the present disclosure with reference to the accompanying drawings. It should be noted that elements in the drawings that are the same or equivalent are labelled using the same reference signs and description thereof is not repeated.

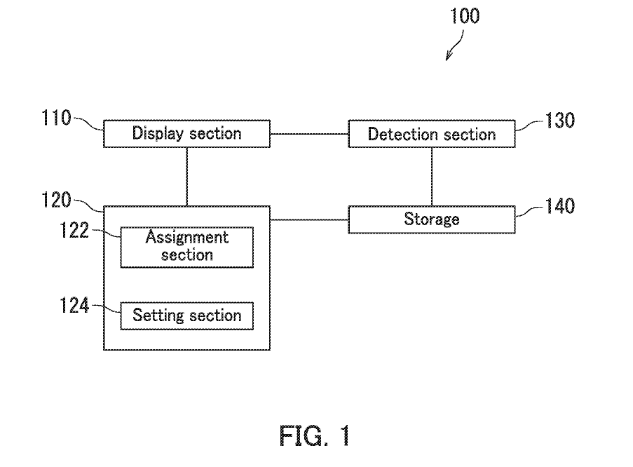

A display device 100 according to the present disclosure will be described with reference to FIG. 1. FIG. 1 is a block diagram of the display device 100.

The display device 100 includes a display section 110, a controller 120, and a detection section 130. The display section 110 displays images. The controller 120 controls the display section 110. The detection section 130 detects operator operations. The controller 120 controls the display section 110 based on the result of detection by the detection section 130.

The controller 120 includes an assignment section 122 and a setting section 124. The assignment section 122 assigns a plurality of candidate selection ranges to an image. The display section 110 may display the candidate selection ranges assigned by the assignment section 122 together with the image.

The setting section 124 sets any of the candidate selection ranges to each be a selected range. The setting section 124 sets for example two adjacent candidate selection ranges among all the candidate selection ranges to selected ranges. Alternatively, the setting section 124 sets two separate candidate selection ranges among all the candidate selection ranges to be different selected ranges.

For example, each set selected range is utilized as a masked range. In the above case, the display section 110 displays an image in which the selected ranges are subjected to masking.

Alternatively, the set selected range may be utilized as a detection range. For example, selected range change in the image is detected by background subtraction or inter-frame differencing. When selected range change in the image is detected, the image is processed as an image in which change is detected.

The display section 110 displays a selected range set by the setting section 124. The display section 110 may display the selected range set by the setting section 124 together with the image. Alternatively, the display section 110 may display the selected range set by the setting section 124 together with the image and the candidate selection ranges.

The detection section 130 detects operator operations. For example, the detection section 130 includes a touch sensor. Alternatively, the detection section 130 may include either or both a keyboard and a mouse.

The detection section 130 detects a candidate selection range among the candidate selection ranges that is specified by the operator. The detection section 130 further detects an operation to switch between setting and non-setting of selected range setting for a specific candidate selection range.

When the operator operates the detection section 130, the detection section 130 detects the operator operation. This enables the setting section 124 to change the selected range setting for the specific candidate selection range. For example, when the detection section 130 detects that the operator has operated a candidate selection range set as a selected range, the setting section 124 can release the selected range setting set for the candidate selection range. By contrast, when the detection section 130 detects that the operator has selected a candidate selection range not set as a selected range, the setting section 124 can set the candidate selection range not set as a selected range to be a selected range. Through the above, a selected range is set according to the operator operation.

Alternatively, in a situation in which the operator performs a predetermined operation on the detection section 130, the detection section 130 detects the operator operation. This enables the setting section 124 to change the selected range setting for the specific candidate selection range. For example, when the detection section 130 detects that the operator has performed a predetermined operation on a candidate selection range, the setting section 124 can release the selected range setting for the candidate selection range. By contrast, when the detection section 130 detects that the operator has performed another predetermined operation on a candidate selection range, the setting section 124 can set the candidate selection range to be a selected range. Through the above, a selected range is set according to the operator operation.

According to the display device 100 of the present embodiment, the detection section 130 detects a first operation to change the selected range setting for a specific candidate selection range. The setting section 124 changes the selected range setting for the specific candidate selection range. Thereafter, when the detection section 130 detects a second operation performed in a specific direction from the specific candidate selection range, the setting section 124 changes, among all the candidate selection ranges, the selected range setting for candidate selection ranges that are located in the specific direction from the specific candidate selection range to the same setting as that set for the specific candidate selection range. In the display device 100, the selected range setting for a plurality of candidate selection ranges located in the specific direction from the specific candidate selection range is changed to the same setting as that set for the specific candidate selection range. Thus, setting or release of the selected range setting can be facilitated.

Preferably, the display device 100 further includes storage 140. The storage 140 stores various data therein. The storage 140 includes a storage device and semiconductor memory. The storage device includes for example either or both a hard disk drive (HDD) and a solid-state drive (SSD). The semiconductor memory includes for example random-access memory (RAM) and read-only memory (ROM).

The storage 140 stores therein programs that the controller 120 executes. The controller 120 controls operation of the display section 110 through execution of the programs stored in the storage 140. The storage 140 may further store an image displayed on the display section 110. In addition, the storage 140 may store candidate selection range assignment to the image.

The following describes setting to selected ranges SR for some of candidate selection ranges CS assigned to an image M in the display device 100 of the present embodiment with reference to FIGS. 1 to 4.

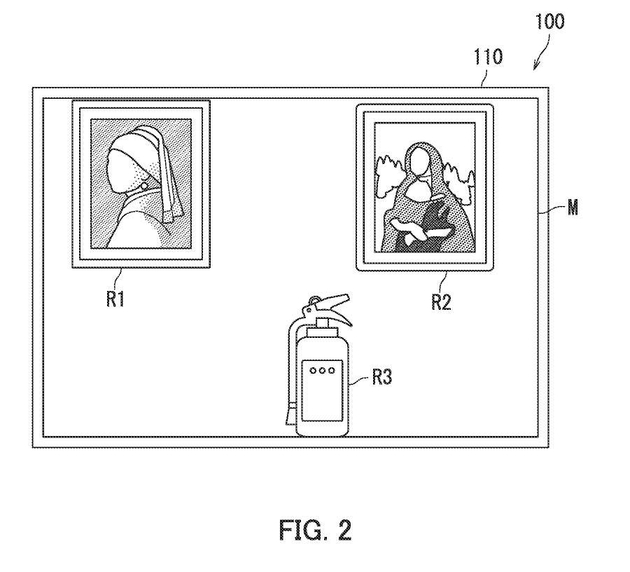

FIG. 2 is a schematic diagram illustrating the display section 110 displaying the image M in the display device 100 of the present embodiment. The display section 110 displays the image M including an image region R1, an image region R2, and an image region R3. The image region R1 is located in an upper left portion of the image M and shows an image of a portrait set in a picture frame. The image region R2 is located in an upper right portion of the image M and shows an image of another portrait set in a picture frame. The image region R3 is located in a lower middle portion of the image M and shows an image of a fire extinguisher.

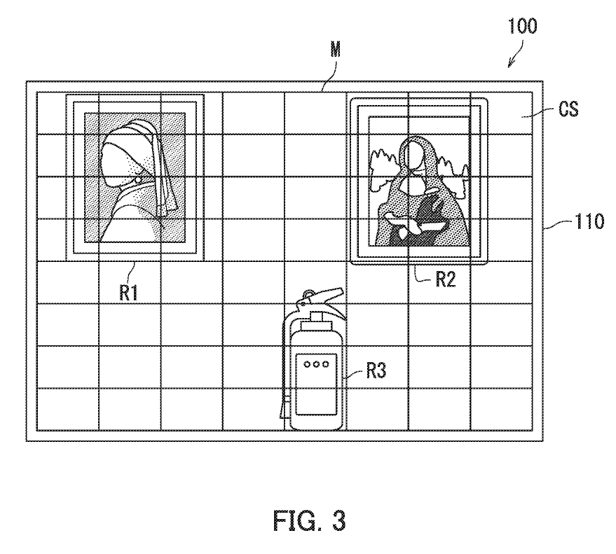

FIG. 3 is a schematic diagram illustrating the display section 110 displaying the image M to which the candidate selection ranges CS are assigned in the display device 100 of the present embodiment. In FIG. 3, the candidate selection ranges CS are assigned to the image M. For example, the operator can assign the candidate selection ranges CS to the image M through the detection section 130 illustrated in FIG. 1 and the assignment section 122 assigns the candidate selection range SC to the image M.

For example, the assignment section 122 assigns to the image M the candidate selection ranges CS arranged in a matrix having a plurality of rows and a plurality of columns. The assignment section 122 herein assigns the candidate selection range CS in eight rows and eight columns to the image M. Note that a length of the image M in a row direction is longer than a length of the image M in a column direction. Likewise, a length of each of the candidate selection ranges CS in the row direction is longer than a length of each of the candidate selection ranges CS in the column direction.

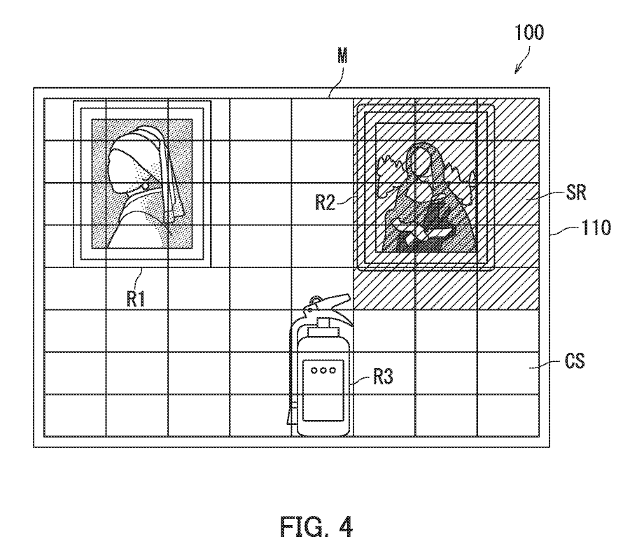

FIG. 4 is a schematic diagram illustrating the display section 110 displaying the image M in which the selected ranges SR are set in the display device 100 of the present embodiment. Among all the candidate selection ranges CS, candidate selection ranges CS located in five rows from the top and in three columns from the right in an upper right portion of the image M including the image region R2 are each set as the selected range SR. The operator sets the candidate selection ranges CS located in the five rows from the top and the three columns from the right in the upper right portion of the image M among all the candidate selection ranges CS to each be the selected range SR using the detection section 130 illustrated in FIG. 1. The setting section 124 sets, to be the selected range SR, each of the candidate selection ranges CS located in the five rows from the top and the three columns from the right in the upper right portion of the image which are assigned to the image M. Through the above, the selected ranges SR are set in the image M.

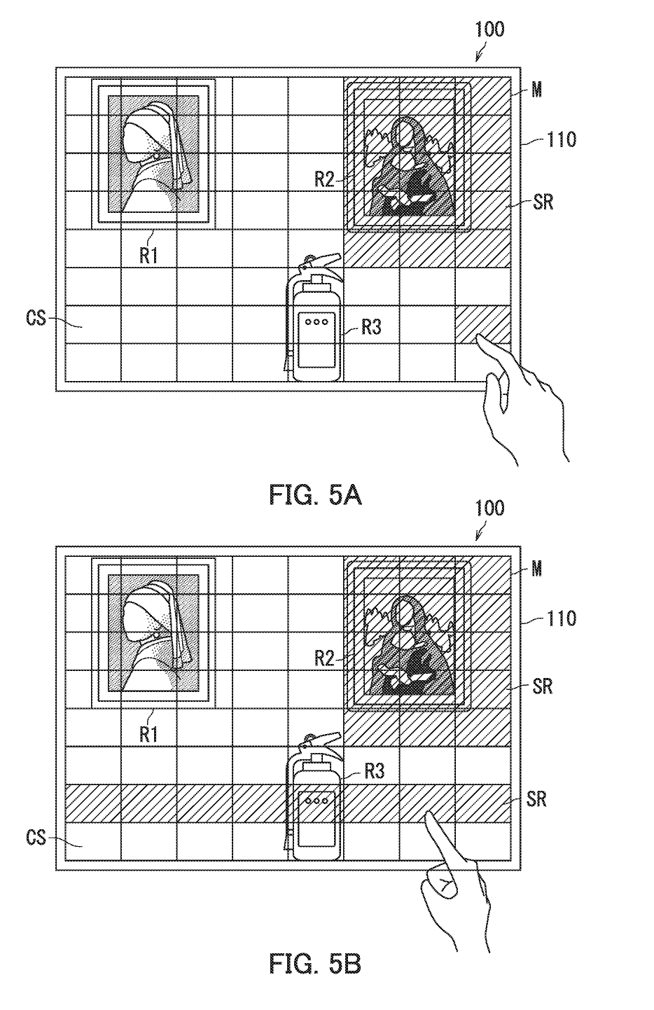

The following describes the selected range setting in the display device 100 of the present embodiment with reference to FIGS. 1, 4, 5A, and 5B. FIG. 5A is a schematic diagram illustrating the display device 100 subjected to the first operation in the present embodiment. FIG. 5B is a schematic diagram illustrating the display device 100 subjected to the second operation in the present embodiment.

In the illustrated example, the selected ranges SR are set prior to the operator performing the first operation on the detection section 130. Specifically, likewise in FIG. 4, the candidate selection ranges CS located in the five rows from the top and the three columns from the right in the upper right portion including the image region R2 are set as the selected ranges SR among all the candidate selection ranges CS.

As illustrated in FIG. 5A, the first operation is performed on any of the candidate selection ranges. For example, the operator performs the first operation on a specific candidate selection range among all the candidate selection ranges. In one example, a tap operation is performed as the first operation. The tap operation as the first operation may be a single tap operation or a double tap operation. The specific candidate selection range subjected to the first operation herein is a candidate selection range not having been set as the selected range SR.

The detection section 130 detects that the first operation is performed on the specific candidate selection range, in an example in which the detection section 130 includes a touch sensor, upon the operator performing a touch operation on the specific candidate selection range, which is the first operation, the touch sensor detects that the specific candidate selection range is touched.

The setting section 124 changes the setting for the candidate selection range subjected to the first operation. The candidate selection range subjected to the first operation has not been set as a selected range herein. The setting section 124 accordingly sets the candidate selection range subjected to the first operation to be a selected range.

As illustrated in FIG. 5B, the second operation is performed after the first operation. For example, the operator performs the second operation in a specific direction from the specific candidate selection range after the first operation. A leftward flick operation is performed as the second operation herein.

The detection section 130 detects that the second operation in the specific direction from the specific candidate selection range subjected to the first operation is performed. In an example in which the detection section 130 includes a touch sensor, the touch sensor detects finger movement in the specific direction as the second operation. For example, it is preferable that the touch sensor detects a touch operation performed as the first operation on a specific candidate selection range by the finger of the operator and then detects movement in the specific direction by the finger of the operator performed as the second operation without separating from the touch sensor.

The setting section 124 specifies candidate selection ranges located in the specific direction from the specific candidate selection ranges among all the candidate selection ranges CS and changes the selected range setting for the candidate selection ranges located in the specific direction to the same setting as that set for the specific candidate selection range. The number of candidate selection ranges specified by the second operation is preferably plural.

The selected range setting is changed for all candidate selection ranges located in a direction in which the second operation is performed herein. The candidate selection ranges located in the direction in which the second operation is performed are each not having been set as a selected range herein. The setting section 124 accordingly sets the candidate selection ranges located in the specific direction to each be a selected range. Specifically, the second operation changes the selected range setting for seven candidate selection ranges except the specific candidate selection range for which the selected range setting has been changed by the first operation and sets each of the seven candidate selection ranges to be a selected range. A series of operations as above can easily change the selected range setting for a plurality of candidate selection ranges.

Note that in the description with reference to FIGS. 1, 5A, and 5B, the second operation is performed in the row direction of the candidate selection ranges CS assigned in a matrix, which should not be taken to limit the present disclosure. The second operation may be performed in the column direction of the candidate selection ranges CS assigned in a matrix.

Furthermore, the second operation by the operator may be performed only on the specific candidate selection range subjected to the first operation. Alternatively, the second operation by the operator may be performed only on one or two candidate selection ranges from the specific candidate selection range subjected to the first operation.

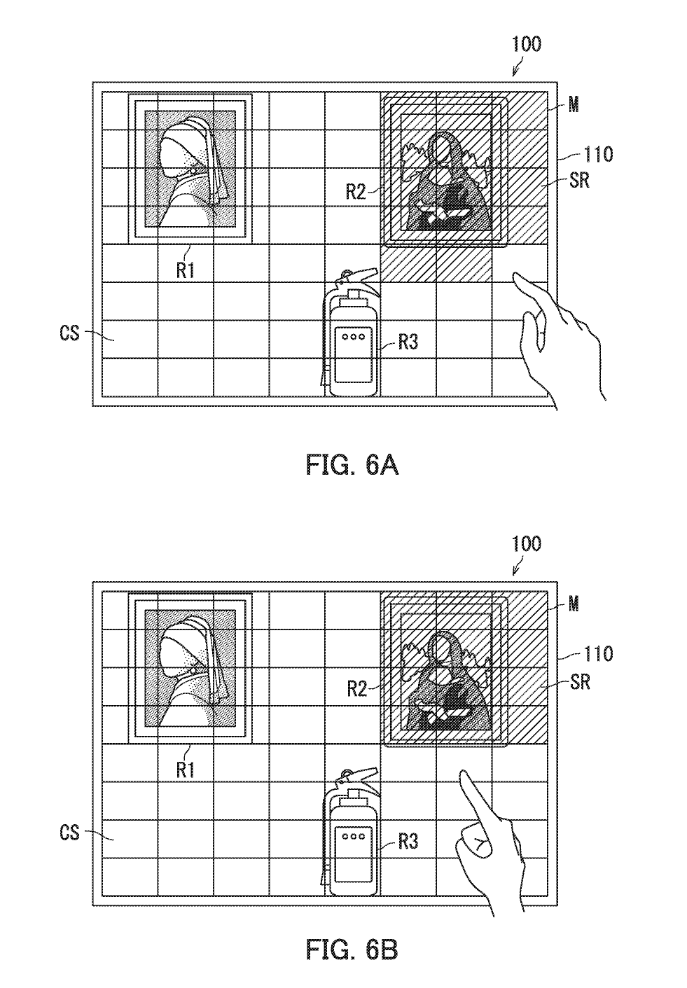

The following describes the selected range setting in the display device 100 of the present embodiment with reference to FIGS. 1, 6A, and 6B. FIG. 6A is a schematic diagram illustrating the display device 100 subjected to the first operation in the present embodiment. FIG. 6B is a schematic diagram illustrating the display device 100 subjected to the second operation in the present embodiment.

Likewise in FIG. 5A, the selected ranges SR are set prior to the operator performing the first operation on the detection section 130. Specifically, likewise in FIG. 4, the candidate selection ranges CS located in the five rows from the top and the three columns from the right in the upper right portion including the image region R2 are set as the selected ranges SR among all the candidate selection ranges CS.

As illustrated in FIG. 6A, the first operation is performed on any of the candidate selection ranges CS each set as a selected range SR. For example, the operator performs the first operation to specify a single candidate selection range having been set as the selected range SR. The detection section 130 detects that the first operation is performed on a specific candidate selection range. In an example in which the detection section 130 includes a touch sensor, upon the operator performing a touch operation on the specific candidate selection range, which is the first operation, the touch sensor detects that the specific candidate selection range is touched.

The setting section 124 specifies candidate selection ranges located in the specific direction from the specific candidate selection range among all the candidate selection ranges CS and changes the selected range setting for the candidate selection ranges located in the specific direction to the same setting as that for the specific candidate selection range. The candidate selection range subjected to the first operation has been set as the selected range SR herein. The setting section 124 accordingly releases the setting to be the selected range SR for the specific candidate selection ranges subjected to the first operation.

As illustrated in FIG. 6B, the second operation is performed after the first operation. For example, the operator performs the first operation and then performs the second operation in a specific direction from the specific candidate selection range subjected to the first operation. A leftward flick operation is performed as the second operation herein.

The detection section 130 detects that the second operation in the specific direction from the specific candidate selection range subjected to the first operation is performed. In an example in which the detection section 130 includes a touch sensor, upon the operator performing finger movement in the specific direction, which is the second operation, the touch sensor detects the finger movement in the specific direction.

The setting section 124 specifies candidate selection ranges located in the specific direction in which the second operation is performed and changes the setting for the candidate selection ranges located in the specified direction. The number of candidate selection ranges specified by the second operation is preferably plural. Some of the candidate selection ranges subjected to the second operation have each been set as a selected range herein. The setting section 124 accordingly releases the corresponding selected range setting for each candidate selection range subjected to the second operation. Specifically, the second operation releases the selected range setting for two candidate selection ranges except the specific candidate selection range for which the selected range setting has been changed by the first operation. A series of operations as above can easily change the selected range setting for a plurality of candidate selection ranges.

Note that the second operation changes the selected range setting for all of the candidate selection ranges located in the specific direction from the specific candidate selection range to the same setting as that set for the specific candidate selection range subjected to the first operation in the above description with reference to FIGS. 1 and 4A to 6B. However, the present disclosure is not limited to the above configuration. It is possible that according to the second operation, the selected range setting is changed for at least one of the candidate selection ranges located in the specific direction from the specific candidate selection range to the same setting as that set for the specific candidate selection range subjected to the first operation.

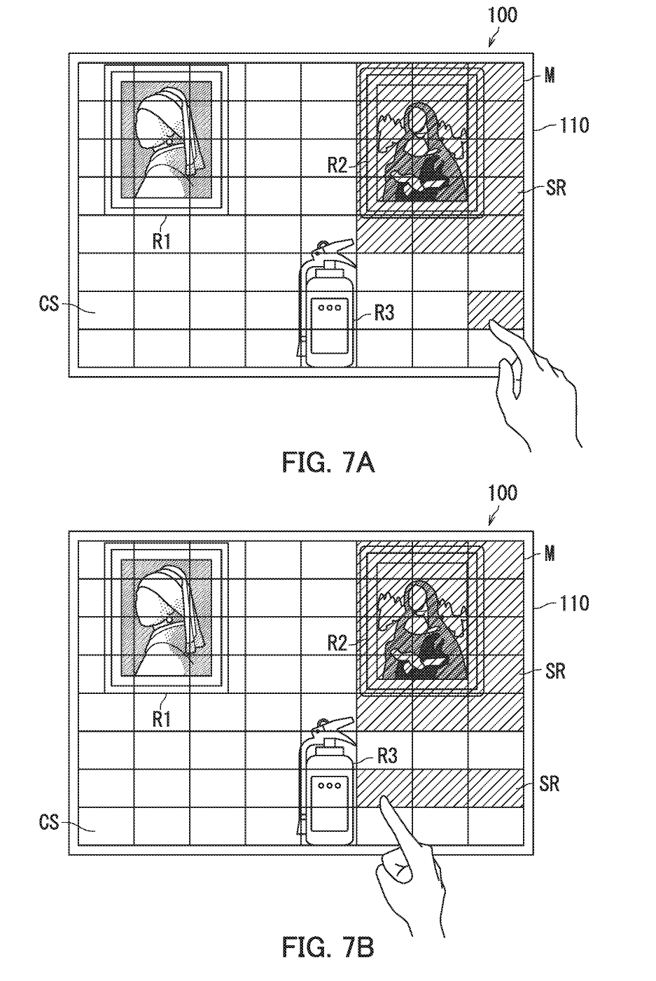

The following describes setting for candidate selection ranges in the display device 100 of the present embodiment with reference to FIGS. 1, 7A, and 7B. FIG. 7A is a schematic diagram illustrating the display device 100 subjected to the first operation in the present embodiment. FIG. 7B is a schematic diagram illustrating the display device 100 subjected to the second operation in the present embodiment.

Likewise in FIGS. 5A to 6B, the selected ranges SR are set prior to the operator performing the first operation on the detection section 130. Specifically, likewise in FIG. 4, the candidate selection ranges CS located in the five rows from the top and the three columns from the right in the upper right portion including the image region R2 are set as the selected ranges SR among all the candidate selection ranges CS.

As illustrated in FIG. 7A, the first operation is performed on any of the candidate selection ranges. For example, the operator performs the first operation on a specific candidate selection range among all the candidate selection ranges. In one example, a tap operation is performed as the first operation. The specific candidate selection range subjected to the first operation herein is a candidate selection range not having been set as the selected range SR.

The setting section 124 changes the selling for the candidate selection range on which the first operation is performed. The candidate selection range on which the first operation is performed has not been set as a selected range herein. The setting section 124 accordingly sets the candidate selection range on which the first operation is performed to be a selected range.

As illustrated in FIG. 7B, the second operation is performed after the first operation. For example, the operator performs the second operation in a specific direction from the specific candidate selection range after the first operation. A leftward flick operation is performed as the second operation herein. The flick operation is performed from the specific candidate selection range to a candidate selection range two regions apart leftward (in the row direction) from the specific candidate selection range. The detection section 130 detects that the second operation in the specific direction is performed on the candidate selection ranges located in a range from the specific candidate selection range subjected to the first operation to a candidate selection range two regions apart therefrom in the specific direction.

The setting section 124 specifies two candidate selection ranges located in the specific direction from the specific candidate selection range among all the candidate selection ranges CS, and changes the selected range setting for the two candidate selection ranges located in the specific direction to the same sating as that set for the specific candidate selection range. The number of candidate selection ranges specified by the second operation is preferably plural.

The candidate selection ranges located in the direction in which the second operation is performed have not been set as selected ranges herein. The setting section 124 accordingly sets each of the candidate selection ranges located in the specific direction to be a selected range. Specifically, the second operation sets each of the two candidate selection ranges to be a selected range except the candidate selection range specified by the first operation. Thus, the selected range setting for a plurality of candidate selection ranges can be easily changed according to a location where the second operation ends.

Note that the location where the second operation ends is utilized for setting each of the candidate selection ranges not having been set as selected ranges to be a selected range in the above description with reference to FIGS. 1, 7A, and 7B. However, the present disclosure is not limited to the above configuration. It is possible that the location where the second operation ends is utilized for releasing the selected range setting for a candidate selection range having been set as a selected range.

Also, the selected range setting for the specific candidate selection range subjected to the first operation is changed by the first operation from the setting set before the first operation is performed in the above description with reference to FIGS. 1 and 4 to 7B, which should not be taken to limit the present disclosure. It is possible that as to the first operation, a given operation on the specific candidate selection range sets the specific candidate selection range to be a selected range while another operation on the specific candidate selection range releases the selected range setting from the specific candidate selection range.

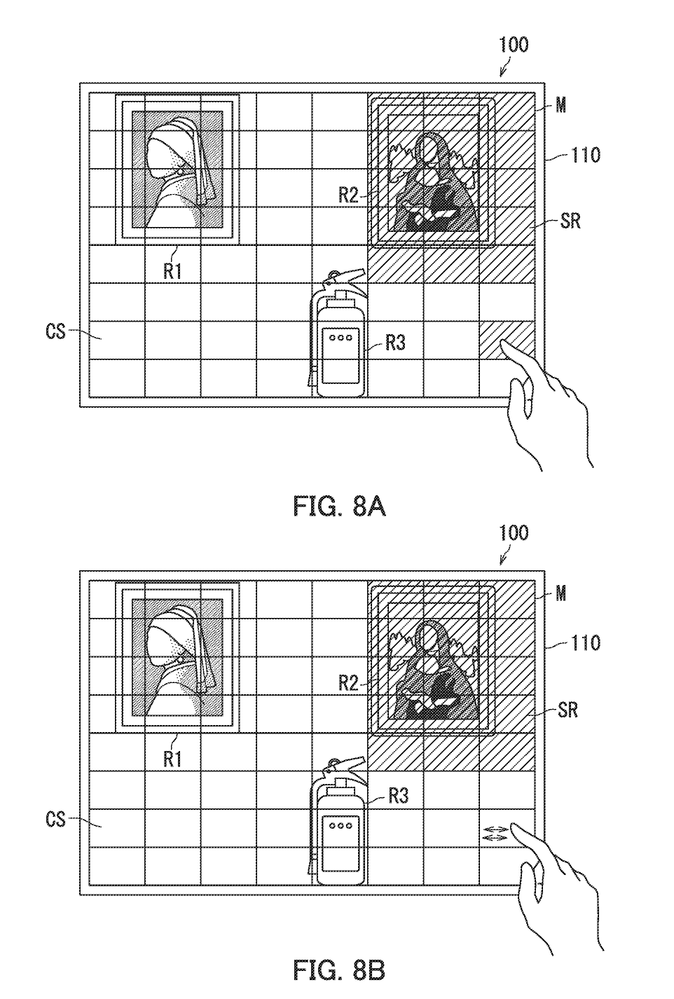

The following describes setting for a candidate selection range in the display device 100 of the present embodiment with reference to FIGS. 1, 8A, and 8B. FIG. 8A is a schematic diagram illustrating the display device 100 subjected to the given operation as the first operation in the present embodiment. FIG. 8B is a schematic diagram illustrating the display device 100 subjected to the other operation as the first operation in the present embodiment.

As illustrated in FIG. 8A, a single tap operation is performed on a specific candidate selection range as the first operation. The detection section 130 detects that the single tap operation is performed on the specific candidate selection range as the first operation. In this case, the setting section 124 sets the specific candidate selection range subjected to the first operation to be a selected range regardless of the selected range setting set for the specific candidate selection range before the first operation.

As illustrated in FIG. 8B, a double tap operation is performed on the specific candidate selection range as the first operation. The detection section 130 detects that the double tap operation is performed on the specific candidate selection range as the first operation. In this case, the setting section 124 releases the selected range setting for the specific candidate selection range subjected to the first operation regardless of the selected range setting set before the first operation. In the above configuration, it can be further ensured for the operator that a specific candidate selection range is set to be a selected range according to a type of the first operation.

Note that the second operation is performed in a direction of rows or columns assigned for the candidate selection ranges in the above description with reference to FIGS. 1 and 4 to 7B, which should not be taken to limit the present disclosure. The second operation may be performed in an oblique direction with respect to the direction of rows or columns assigned for the candidate selection ranges.

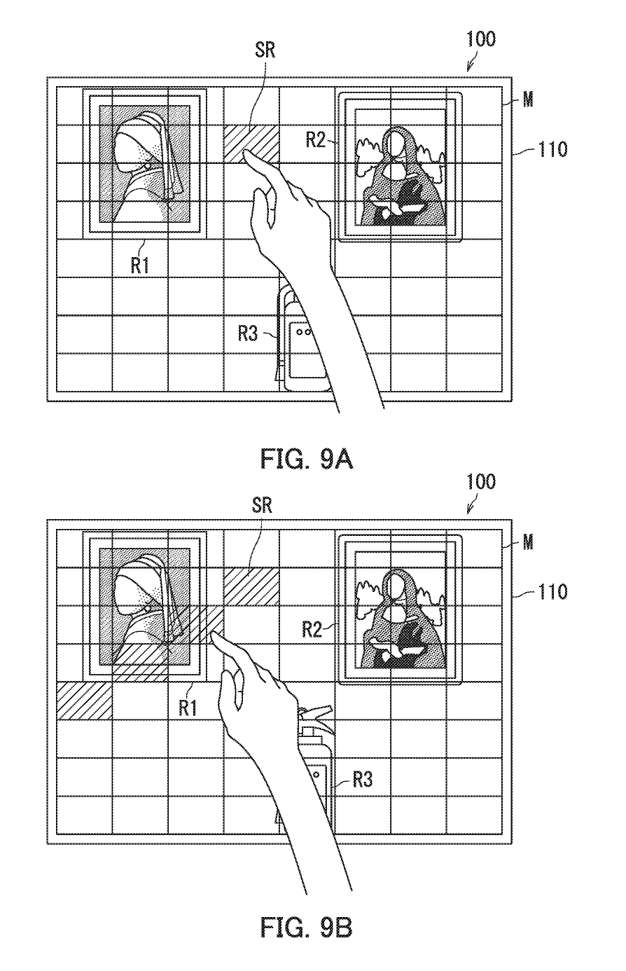

The following describes setting for candidate selection ranges in the display device of the present embodiment with reference to FIGS. 1, 9A, and 9B. FIG. 9A is a schematic diagram illustrating the display device subjected to the first operation in the present embodiment. FIG. 9B is a schematic diagram illustrating the display device 100 subjected to the second operation in the present embodiment.

As illustrated in FIG. 9A, the first operation is performed on any of the candidate selection ranges. For example, the operator performs the first operation to specify one of the candidate selection ranges. The assignment section 122 assigns to the image M the candidate selection range CS arranged in a matrix having a plurality of rows and a plurality of columns herein.

The operator performs the first operation on a single candidate selection range. A tap operation is performed as the first operation herein. For example, the operator performs the first operation to specify a single candidate selection range not having been set as a selected range. The detection section 130 detects that the first operation is performed on the specific candidate selection range. In an example in which the detection section 130 includes a touch sensor, upon the operator performing a touch operation on the specific candidate selection range, which is the first operation, the touch sensor detects that the specific candidate selection range is touched.

The setting section 124 changes the setting for the candidate selection range subjected to the first operation. The candidate selection range subjected to the first operation has not been set as a selected range herein. The setting section 124 accordingly sets the candidate selection range subjected to the first operation to be a selected range.

As illustrated in FIG. 9B, the second operation is performed after the first operation. For example, the operator performs the second operation in a specific direction from the candidate selection range subjected to the first operation after the first operation. A flick operation in an oblique direction is performed as the second operation herein.

The detection section 130 detects that the second operation in the oblique direction is performed from the specific candidate selection range subjected to the first operation. In an example in which the detection section 130 includes a touch sensor, upon the operator performing finger movement in the specific direction, which is the second operation, the touch sensor detects the finger movement in the specific direction.

The setting section 124 specifies candidate selection ranges located in the specific direction in which the second operation is performed, and changes the setting for the specified candidate selection ranges. The number of candidate selection ranges specified by the second operation is preferably plural. The candidate selection ranges subjected to the second operation have not been set selected ranges herein. The setting section 124 accordingly sets each of the candidate selection ranges subjected to the second operation to be a selected range. Specifically, the second operation sets three candidate selection ranges to be selected ranges except the candidate selection range specified by the first operation.

In the above configuration, upon the detection section 130 detecting the second operation performed in an oblique direction, the setting section 124 changes the selected range setting for candidate selection ranges located in the specific direction from the specific candidate selection range to the same setting as that set for the specific candidate selection range. Through a series of operations as above, the selected range setting for a plurality of candidate selection ranges can be easily changed.

In the above description with reference to FIGS. 1, 9A, and 9B, in a situation in which the second operation is performed in an oblique direction, candidate selection ranges located on a straight line in the oblique direction with respect to the specific candidate selection range are selected as targets for selected range setting change, which should not be taken to limit the present disclosure. In a situation in which the second operation is performed in an oblique direction, candidate selection ranges included in rows and columns specified by the second operation in the oblique direction may be selected as targets for selected range setting change.

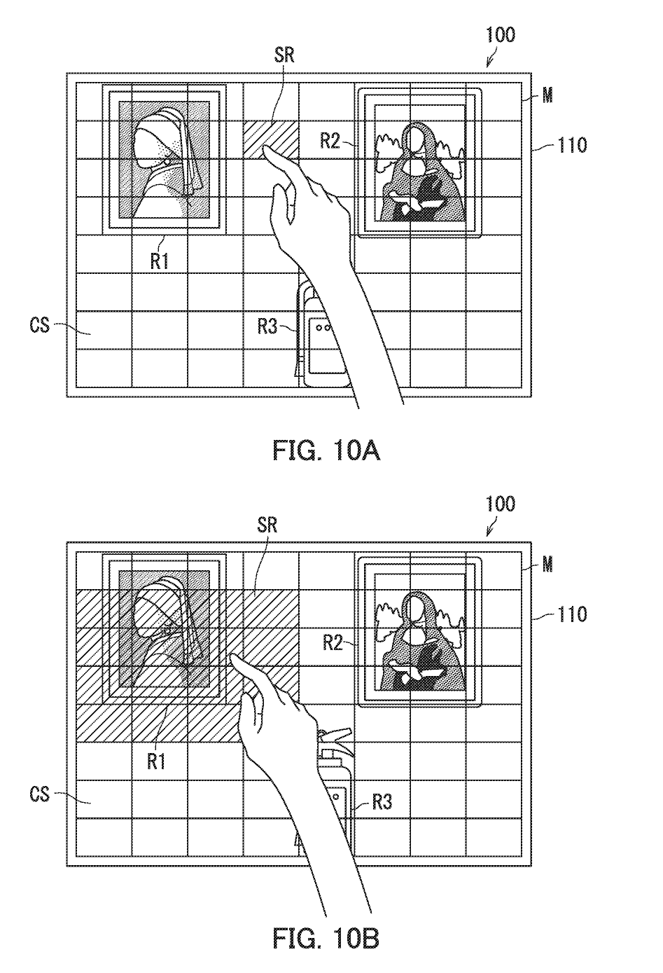

The following describes setting for candidate selection ranges in the display device 100 of the present embodiment with reference to FIGS. 1, 10A, and 10B. FIG. 10A is a schematic diagram illustrating the display device subjected to the first operation in the present embodiment. FIG. 10B is a schematic diagram illustrating the display device subjected to the second operation in the present embodiment.

As illustrated in FIG. 10A, the first operation is performed on any of the candidate selection ranges. For example, the operator performs the first operation on one of the candidate selection ranges for specification. The assignment section 122 assigns the candidate selection ranges CS arranged in a matrix having a plurality of rows and a plurality of columns to the image M.

The operator performs the first operation on one of the candidate selection ranges, for example. A tap operation is performed as the first operation herein. For example, the operator performs the first operation to specify a single candidate selection range not having been set as a selected range. The detection section 130 detects that the first operation is performed on a specific candidate selection range. In an example in which the detection section 130 includes a touch sensor, upon the operator performing a touch operation on the specific candidate selection range, which is the first operation, the touch sensor detects that the specific candidate selection range is touched.

The setting section 124 changes the setting for the candidate selection range subjected to the first operation. The candidate selection range subjected to the first operation has not been set as a selected range. The setting section 124 accordingly sets the candidate selection range subjected to the first operation to be a selected range.

As illustrated in FIG. 10B, the second operation is performed after the first operation. For example, the operator performs the second operation in a specific direction from the candidate selection range subjected to the first operation after the first operation. A flick operation in an oblique direction is performed as the second operation herein.

The detection section 130 detects that the second operation in the oblique direction from the specific candidate selection range subjected to the first operation is performed. In an example in which the detection section 130 includes a touch sensor, upon the operator performing finger movement in the specific direction, which is the second operation, the touch sensor detects the finger movement in the specific direction.

The setting section 124 specifies candidate selection ranges located in the direction in which the second operation is performed and changes the setting for the specified candidate selection ranges. The number of candidate selection ranges located in the direction in which the second operation is performed is preferably plural. When the detection section 130 detects that the second operation is performed in the specific direction that is an oblique direction, the setting section 124 changes the selected range setting for candidate selection ranges included in some rows and some columns defined according to the specific direction among all the specific candidate selection ranges to the same setting as that set for the specific candidate selection range.

Specifically, a candidate selection range located at a far end from the specific candidate selection range in the oblique direction is three rows downwardly apart and three columns leftwardly apart from the specific candidate selection range. The setting section 124 accordingly changes the selected range setting for the candidate selection ranges included in three rows and three columns selected from among the rows and columns of all the specific candidate selection ranges according to the specific direction to the setting as that set for the specific candidate selection range.

Each of the candidate selection ranges subjected to the second operation has not been set as a selected range. The setting section 124 accordingly sets the candidate selection ranges subjected to the second operation to each be the selected range. Specifically, the second operation sets 15 candidate selection ranges to be selected ranges except the candidate selection range specified by the first operation. A series of operations as above can easily change the selected range setting for a plurality of candidate selection ranges.

Note that all candidate selection ranges are selected that are located in the direction in which the second operation is performed with respect to the specific candidate selection range subjected to the first operation in the description with reference to FIGS. 1 to 10, which should not be taken to limit the present disclosure. Selection of candidate selection ranges located in a direction in which the second operation is performed with respect to the specific candidate selection range subjected to the first operation may be done utilizing a position where the second operation ends. For example, in a situation in which the position where the second operation ends is separate downwardly by one row and leftwardly by one column with respect to the specific candidate selection range subjected to the first operation as illustrated in FIG. 10B, the setting section 124 may set to each be the selected range three candidate selection ranges except the candidate selection range specified by the first operation.

The selected range setting change is performed for the entire area of a candidate selection range in the description with reference to FIGS. 1 to 10B, which should not be taken to limit the present disclosure. Selected range setting change may be performed on a portion of a candidate selection range.

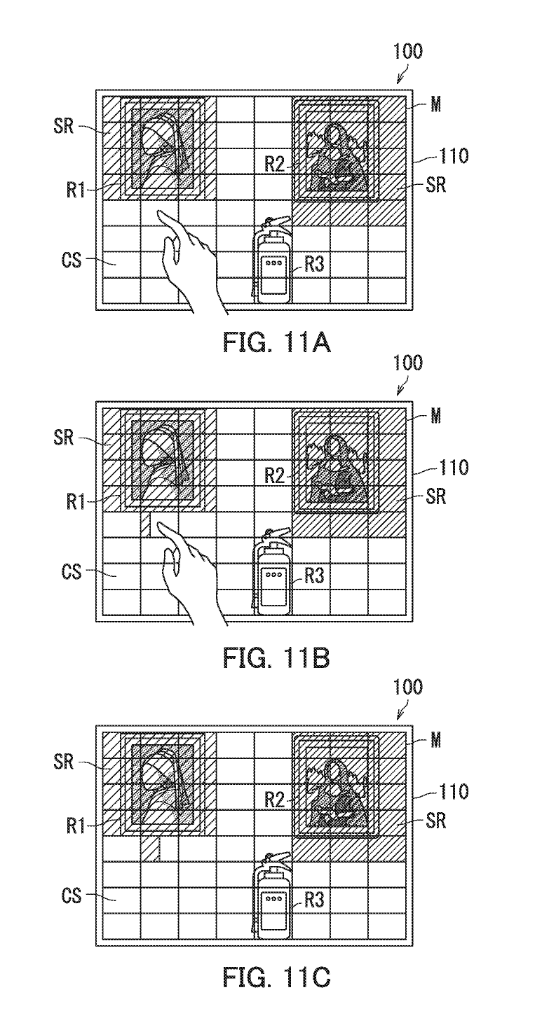

The following describes selected range setting in the display device 100 of the present embodiment with reference to FIGS. 1 and 11A to 11C. The selected range setting is changed by a third operation different from the above-described first and second operations on a portion of a candidate selection range. FIG. 11A is a schematic diagram illustrating the display device directly before the third operation is performed in the embodiment. FIG. 11B is a schematic diagram illustrating the display device in course of the third operation being performed in the present embodiment. FIG. 11C is a schematic diagram illustrating the display device after the third operation is performed in the embodiment.

As illustrated in FIG. 11A, the third operation is performed on any of the candidate selection ranges. For example, the operator performs the third operation on one of the candidate selection ranges.

A candidate selection range other than the candidate selection ranges each set as a selected range SR is specified by the third operation herein. For example, the operator performs the third operation on a single candidate selection range. A long press operation is performed as the third operation herein.

The detection section 130 detects the third operation being performed on a candidate selection range. Here, the operator performs the third operation on the single candidate selection range not having been set as a selected range, and the detection section 130 accordingly detects that the third operation has been performed on a specific candidate selection range.

Note that the detection section 130 may detect the first operation and the third operation as different operations according to duration of the operations. For example, in a situation in which duration for which the operator specifies a specific candidate selection range is shorter than one second, the detection section 130 may detect the above operation as the first operation. By contrast, in a situation in which duration for which the operator specifies a specific candidate selection range is equal to or longer than one second, the detection section 130 may detect the above operation as the third operation.

In a configuration in which the detection section 130 includes a touch sensor, the detection section 130 detects the first operation and the third operation as different operations according to duration for which the operator touches a specific candidate selection range. In an example in which duration for which the operator touches the specific candidate selection range is shorter than one second, the detection section 130 may detect the above operation as the first operation. By contrast, in a situation in which duration for which the operator touches the specific candidate selection range is equal to or longer than one second, the detection section 130 may detect the above operation as the third operation.

Alternatively, in a configuration in which the detection section 130 includes either or both a keyboard and a mouse, when the operator selects a specific candidate selection range and presses a specific button, the detection section 130 detects the first operation and the third operation as different operations according to duration of the button being pressed. In an example, in a situation in which duration for which the operator having selected the specific candidate selection range presses the specific button is shorter than one second, the detection section 130 may detect the above operation as the first operation. By contrast, in a situation in which duration for which the operator having selected the specific candidate selection range presses the specific button is equal to or longer than one second, the detection section 130 may detect the above operation as the third operation.

According to the third operation, the selected range setting is changed for a portion of the candidate selection range subjected to the third operation as illustrated in FIG. 11B. When the detection section 130 detects that the third operation is performed on any of the candidate selection ranges, the setting section 124 sets a portion of the candidate selection range subjected to the third operation to be a selected range.

The candidate selection range subjected to the third operation has not been set as a selected range. The setting section 124 accordingly sets the portion of the candidate selection range subjected to the third operation to be a selected range. Note that an area of the portion of the candidate selection range for which the selected range setting is changed may differ according to the third operation. A left portion of the candidate selection range is set to be a selected range herein.

It is possible that once the detection section 130 detects the third operation, the setting section 124 measures operation duration for which the third operation is performed. The setting section 124 increases, according to the duration of the third operation, the area of the portion of the candidate selection range subjected to the third operation that is to be set to be a selected range. For example, when the third operation is performed for three seconds, the setting section 124 sets ¼ of the candidate selection range subjected to third operation to be a selected range.

The area of the portion of the candidate selection ranges subjected to the third operation that is to be set to be a selected range is increased according to the duration of the third operation as illustrated in FIG. 11C. For example, when the third operation is performed for five seconds, the setting section 124 sets ½ of the candidate selection range subjected to the third operation to be a selected range. Through the above, the selected range setting can be changed for a portion of a candidate selection range.

Note that the area of a portion of the candidate selection range for which the selected range setting is changed by the third operation varies according to the duration of the third operation in the above description with reference to FIGS. 1 and 11A-11C, which should not be taken to limit the present disclosure. The area of a portion of the candidate selection range for which the selected range setting is changed by the third operation may be fixed regardless of the duration of the third operation.

The detection section 130 detects a third operation performed on the candidate selection range not having been set as a selected range in the above description with reference to FIGS. 1 and 11A to 11C, which should not be taken to limit the present disclosure. The detection section 130 may detect the third operation performed on a candidate selection range having been set as a selected range. In this case, the setting section 124 may release the selected range setting set for the portion of the candidate selection range subjected to the third operation.

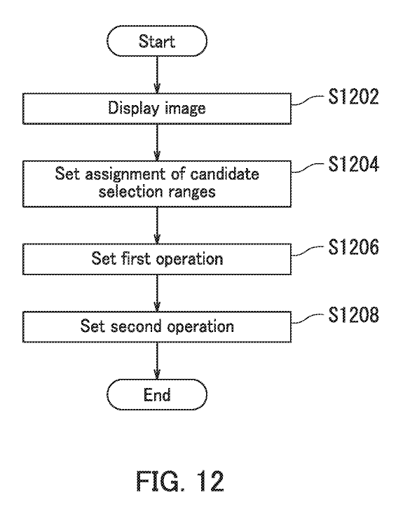

The following describes selection candidate range assignment and operation setting in the display device 100 of the present embodiment with reference to FIGS. 1 and 12. FIG. 12 is a flowchart depicting selection candidate range assignment and operation setting in the display device 100 of the embodiment.

First, an image is displayed (S1202). For example, the display section 110 displays an image based on image data stored in the storage 140.

Next, assignment of a plurality of candidate selection ranges CS is set for the image (S1204). The detection section 130 detects operator input of the candidate selection ranges CS. For example, the detection section 130 detects input of the number of rows and the number of columns for assignment through division of the image into the candidate selection ranges CS. In an example, once the detection section 130 detects input of 8 as the number of rows and 8 as the number of columns for image division, the assignment section 122 assigns 64 candidate selection ranges CS arranged in eight rows and eight columns to the image M as illustrated in FIG. 3. The storage 140 stores assignment of the candidate selection ranges CS.

Subsequently, the first operation is set (S1206). The operator sets a first operation through the detection section 130. In an example, the display section 110 displays a screen for first operation setting and receives first operation setting by the operator. Upon the detection section 130 detecting the user operation, a first operation performed by the operator is set as the first operation. For example, the first operation is a tap operation.

In a configuration in which the detection section 130 includes a touch sensor mounted on a display included in the display section 110, the detection section 130 detects a first operation performed by the operator on the touch sensor and the storage 140 stores the first operation. Alternatively, in a configuration in which the detection section 130 includes either or both a keyboard and a mouse, the detection section 130 detects a first operation performed by the operator on either or both the keyboard and the mouse and the storage 140 stores the first operation. Through the above, the first operation can be set.

Next, the second operation is set (S1208). The operator sets a second operation through the detection section 130. The second operation is an operation indicating a direction. In an example, the display section 110 displays a screen for second operation setting and receives second operation setting by the operator. Through the detection section 130 detecting the operator operation, the operation performed by the operator is set as the second operation. The detection section 130 may limit a direction to be detected as the second operation. For example, it is possible that the detection section 130 detects upward and downward operations as second operations but does not detect rightward and leftward operations as second operations.

In a configuration in which the detection section 130 includes a touch sensor mounted on a display included in the display section 110, the detection section 130 detects a second operation performed on the touch sensor by the operator and the storage 140 stores the second operation. Alternatively, in a configuration in which the detection section 130 includes either or both a keyboard and a mouse, the detection section 130 detects a second operation performed on either or both the keyboard and the mouse by the operator and the storage 140 stores the second operation. Through the above, the second operation can be set. Thus, the first operation and the second operation can be set in the display device 100.

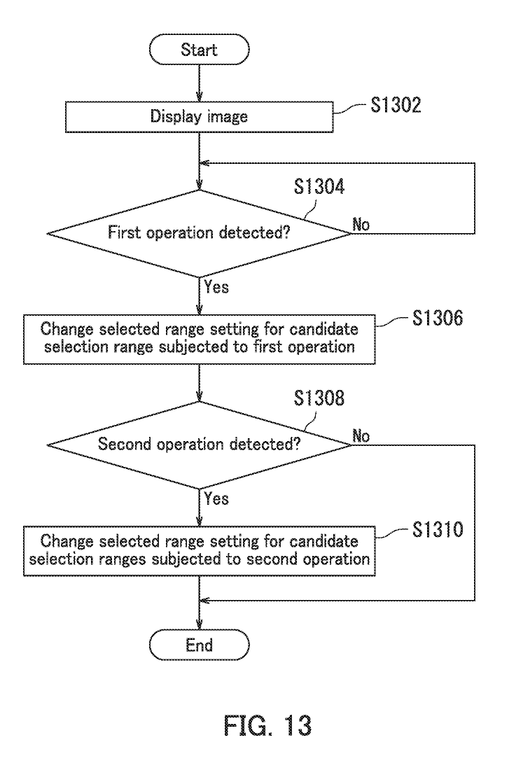

The following describes the selected range setting in the display device 100 of the present embodiment with reference to FIGS. 1 and 13, FIG. 13 is a flowchart depicting the selected range setting in the display device 100 of the embodiment.

First, an image is displayed (S1302). For example, the display section 110 displays the image based on image data stored in the storage 140. Note that the display section 110 preferably displays candidate selection ranges assigned by the assignment section 122 together with the image.

Next, the controller 120 determines whether or not the detection section 130 has detected the first operation (S1304). Upon determining that the detection section 130 has not detected the first operation (No in S1304), the controller 120 repeats the determination until the detection section 130 detects the first operation. Upon the controller 120 determining that the detection section 130 has detected the first operation (Yes in S1304), the setting section 124 changes the selected range setting for a specific candidate selection range on which the first operation is performed (S1306).

Thereafter, the controller 120 determines whether or not the detection section 130 has detected the second operation (S1308). For example, the controller 120 determines whether or not the detection section 130 has detected the second operation after detection of the first operation (S1308). Upon determining that the detection section 130 has not detected the second operation (No in S1308), the controller 120 terminates the selected range setting.

Upon the controller 120 determining that the detection section 130 has detected the second operation (Yes in S1308), the setting section 124 changes the selected range setting for candidate selection ranges located in a direction in which the second operation is performed (S1308). Through the above, the display device 100 can perform the selected range setting.

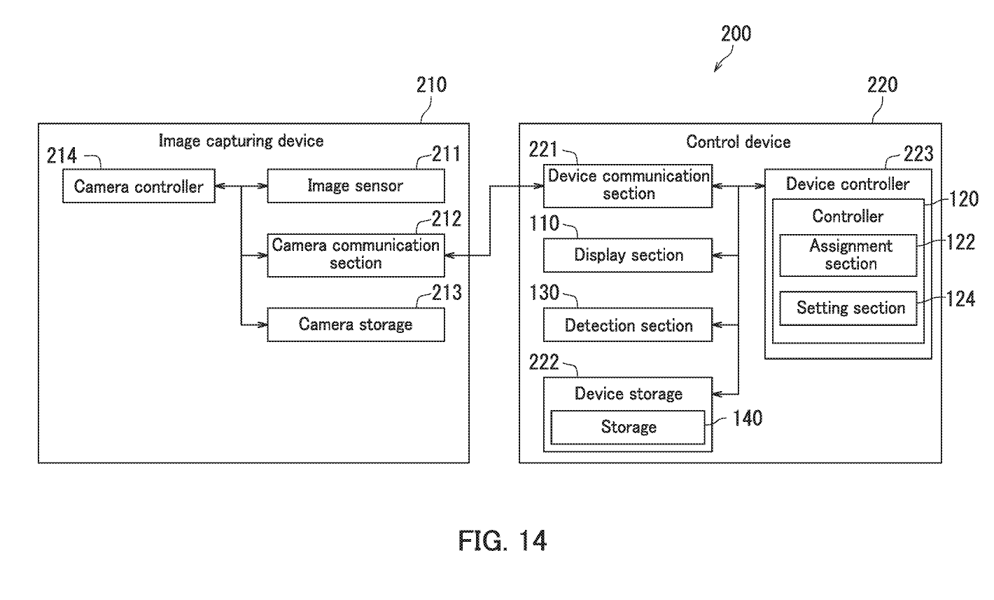

Note that the display device 100 of the present embodiment can be suitably applied to monitoring systems. The following describes a monitoring system 200 including the display device 100 with reference to FIG. 14.

The monitoring system 200 includes an image capturing device 210 and a control device 220. The image capturing device 210 captures an image in an imaging area and generates captured image data indicating the captured image. The captured image captured by the image capturing device 210 may be video or still. The control device 220 controls the image capturing device 210. For example, the control device 220 is disposed separate from the image capturing device 210. The control device 220 is for example a server.

The image capturing device 210 includes an image sensor 211, a camera communication section 212, camera storage 213, and a camera controller 214. The camera controller 214 controls the image sensor 211 and the camera communication section 212.

The image sensor 211 captures an image in the imaging area. The image sensor 211 generates captured image data indicating the captured image and transmits the captured image data to the camera controller 214. The image sensor 211 includes for example a charge-coupled device (CCD) image sensor or a complementary metal-oxide-semiconductor (CMOS) image sensor.

The camera communication section 212 is capable of communicating with an electronic device equipped with a communication device that uses the same communication method (protocol) as the camera communication section 212. The camera communication section 212 communicates with the control device 220 through a network such as a local area network (LAN). The camera communication section 212 is for example a communication module (communication device) such as a LAN board. The camera communication section 212 transmits the captured image data to the control device 220 in the present embodiment.

The camera storage 213 stores various data therein. The camera storage 213 includes semiconductor memory. The semiconductor memory includes for example RAM and ROM.

The camera storage 213 stores camera control programs therein. Also, the camera storage 213 transitorily stores therein the captured image data generated by the image sensor 211. Furthermore, the camera storage 213 deletes the stored captured image data when unnecessary.

The camera controller 214 controls operations of each section of the image capturing device 210 by executing the camera control programs stored in the camera storage 213. The camera controller 214 includes a processor. The processor may include a central processing unit (CPU). Alternatively, the processor may include a microcomputer. Alternatively, the processor may include an application specific integrated circuit.

The camera controller 214 detects change of a detection range in the captured image based on the captured image data. Data indicating the detection range is stored in the camera storage 213. The camera controller 214 detects detection range change in the captured image for example by background subtraction. Alternatively, the camera controller 214 detects detection range change in the captured image by inter-frame difference. The detection range is preset for example by an administrator of the monitoring system 200. Upon detecting detection range change in the captured image, the camera controller 214 transmits change detection data to the control device 220. The change detection data is captured image data of a captured image in which detection range change is detected.

The control device 220 includes a display section 110, a detection section 130, a device communication section 221, device storage 222, and a device controller 223. The device controller 223 controls the display section 110 and the device communication section 221.

The device communication section 221 is capable of communicating with an electronic device equipped with a communication device that uses the same communication method (protocol) as the device communication section 221. The device communication section 221 communicates with the camera communication section 212 through a network such as a LAN. The device communication section 221 is a communication module (communication device) such as a LAN board. The device communication section 221 receives the captured image data from the camera communication section 212 in the present embodiment. Upon the camera controller 214 detecting change of the captured image, the device communication section 221 receives the change detection data from the camera communication section 212.

The detection section 130 detects an operation on the control device 220. The detection section 130 includes a touch sensor in the present embodiment. Alternatively, the detection section 130 includes either or both a keyboard and a mouse.

The display section 110 displays the captured image based on the captured image data received by the device communication section 221. The display section 110 includes a liquid-crystal display in the present embodiment.

The device storage 222 stores various data therein. The device storage 222 includes a storage device and semiconductor memory. The storage device includes for example either or both an HDD and an SSD. The semiconductor memory includes for example RAM and ROM.

The device storage 222 stores device control programs therein. The device storage 222 further stores therein the captured image data that the device communication section 221 receives from the camera communication section 212. The device storage 222 further stores therein the change detection data that the device communication section 221 receives from the camera communication section 212.

The device storage 222 may additionally store detection target image data therein. The detection target image data indicates an image of a detection target that is a to-be-detected object preset by the administrator.

The device storage 222 may store reference background data therein. The reference background data indicates a reference background image that serves as a reference to the captured image. For example, the reference background image indicates a background image in a state before the detection target is present in the imaging area captured by the image sensor 211. Alternatively, the reference background image indicates a background image in a state in which the detection target is installed in the imaging area captured by the image sensor 211.

Moreover, the device storage 222 further includes the storage 140 described with reference to FIG. 1. The storage 140 stores therein programs for controlling the display section 110.

The device controller 223 controls each section included in the control device 220 by executing the device control programs stored in the device storage 222. The device controller 223 includes a processor. The processor may include a central processing unit. Alternatively, the processor may include a microcomputer. Alternatively, the processor may include an application-specific integrated circuit.

The device controller 223 receives detection range setting performed by the administrator. The device controller 223 causes the display section 110 for example to display a screen for detection range setting. In the screen for the setting being displayed, the administrator operates the detection section 130 to set a detection range. Data indicating the detection range is transmitted to the camera communication section 212 through the device communication section 221. When the camera communication section 212 receives the data indicating the detection range, the camera controller 214 stores the data indicating the detection range in the camera storage 213. The camera controller 214 detects change of the captured image based on the data indicating the detection range stored in the camera storage 213.

Upon the detection section 130 receiving an instruction to display the captured image, the device controller 223 causes the display section 110 to display the captured image based on the captured image data received by the device communication section 221. Alternatively, the device controller 223 causes the display section 110 to display the captured image based on the captured image data stored in the device storage 222.

The device controller 223 includes the controller 120 for controlling the display section 110 in the monitoring system 200 of the present embodiment. As described above, the controller 120 includes the assignment section 122 and the setting section 124. The assignment section 122 sets assignment of a plurality of candidate selection ranges to the captured image. The assignment section 122 performs for example assignment of the candidate selection ranges to the captured image stored in the device storage 222.

The setting section 124 sets any of the candidate selection ranges to each be a selected range. The setting section 124 may set several adjacent candidate selection ranges to be a single selected range. Alternatively, the setting section 124 may set separate candidate selection ranges to each be a selected range.

For example, the setting section 124 sets any of the candidate selection ranges to be a detection range. It is possible that the detection range set by the setting section 124 is transmitted to the image capturing device 210 through the device communication section 221 to be set as a range to be subjected to detection by the image capturing device 210. Alternatively, the detection range set by the setting section 124 may be set as a range to be subjected to detection by the control device 220 different from detection by the image capturing device 210.

Alternatively, the setting section 124 may set any of the candidate selection ranges to be a mask region. The setting section 124 performs mask region setting on the captured image data transmitted from the image capturing device 210 to the control device 220 to set a mask region where masking is performed.

The device controller 223 processes the selected range of the captured image based on the captured image data. For example, the device controller 223 detects the selected range of the captured image based on the captured image data. In this case, the device controller 223 detects only the candidate selection ranges set as a selected range. Therefore, a necessary amount of data processing can be reduced when compared to detection on the entire captured image.

The device controller 223 detects selected range change in the captured image stored in the device storage 222 as detection range change. In this case, data indicating the detection range is stored in the device storage 222. The device controller 223 detects for example detection range change in the captured image by background subtraction. Alternatively, the device controller 223 detects detection range change in the captured image by inter-frame difference. Upon detecting detection range change in the captured image, the device controller 223 causes the device storage 222 to maintain storage of the captured image.

Note that the device controller 223 may detect detection target change in the detection range change in the captured image. For example, the device controller 223 detects movement of the detection target in the captured image. In this case, upon detecting detection target change in the captured image, the device controller 223 causes the device storage 222 to maintain storage of the captured image.

Alternatively, the device controller 223 may detect reference background change in the detection range change in the captured image. For example, the device 223 detects that capture of the reference background is inhibited based on a fact that a part of the reference background is not included in the captured image for a specific time period. For example, when the reference background included in the detection range of the capture image is obstructed from the left to the right in a sequential manner, the device controller 223 can detect that an obstacle obstructing the reference background passes from the left to the right. Upon detecting that capture of the reference background of the captured image is inhibited, the device controller 223 causes the device storage 222 to maintain storage of the captured image.

Alternatively, the device controller 223 may mask a selected range of the captured image based on the captured image data. The device controller 223 selects and masks only a specific candidate selection range of the captured image. Thus, privacy issues can be obviated even when the capture image is displayed on the display section 110.

The embodiment of the present disclosure has been described so far with reference to the drawings (FIGS. 1 to 14). However, the present disclosure is not limited to the above-described embodiment and can be practiced in various ways within the scope not departing from the gist of the present disclosure. Configurations described in the above embodiment are exemplary only and not particularly limited, and can be changed within a scope not substantially departing from the effects of the present disclosure.

What is claimed is:

1. A display device comprising:
a display section configured to display an image;
an assignment section configured to assign a plurality of candidate selection ranges to the image;
a setting section configured to perform selected range setting, the selected range setting being a setting to set any of the candidate selection ranges to each be a selected range; and
a detection section configured to detect an operation to cause the setting section to change between setting and non-setting of the selected range setting for a selected candidate selection range, the selected candidate selection range being selected from among the candidate selection ranges, wherein
in a situation in which the detection section detects a first operation to change the selected range setting for a specific candidate selection range among the candidate selection ranges and then detects a second operation performed in a specific direction from the specific candidate selection range, the setting section changes the selected range setting for the specific candidate selection range and changes the selected range setting for a candidate selection range located in the specific direction from the specific candidate selection range among the candidate selection ranges to the same setting as that set for the specific candidate selection range.

2. The display device according to claim 1, wherein
the detection section detects a tap operation as the first operation, and
the detection section detects a flick operation as the second operation.

3. The display device according to claim 1, wherein
when the detection section detects a single tap operation as the first operation, the setting section sets the specific candidate selection range to be the selected range, and
when the detection section detects a double tap operation as the first operation, the setting section releases the selected range setting set for the specific candidate selection range.

4. The display device according to claim 1, wherein
in a situation in which the specific candidate selection range is not set as the selected range when the detection section detects the first operation, the setting section sets the specific candidate selection range to be the selected range, and
in a situation in which the specific candidate selection range is set as the selected range when the detection section detects the first operation, the setting section releases the selected range setting set for the specific candidate selection range.

5. The display device according to claim 1, wherein
the assignment section assigns the candidate selection ranges arranged in a matrix having a plurality of rows and a plurality of columns to the image, and
when the detection section detects that the specific direction in which the second operation is performed is an oblique direction, the setting section changes the selected range setting for a candidate selection range that is located in the specific direction from the specific candidate selection range among the candidate selection ranges to the same setting as that set for the specific candidate selection range.

6. The display device according to claim 1, wherein
the assignment section assigns the candidate selection ranges arranged in a matrix having a plurality of rows and a plurality of columns to the image, and
when the detection section detects that the specific direction in which the second operation is performed is an oblique direction, the setting section changes the selected range setting for some of the candidate selection ranges to the same setting as that set for the specific candidate selection range, the some of the candidate selection ranges being included in some of the rows and some of the columns each defined according to the specific direction from the specific candidate selection range.

7. The display device according to claim 1, wherein
when the detection section detects a third operation performed on one of the candidate selection ranges, the setting section sets a portion of the one of the candidate selection ranges that is subjected to the third operation to be the selected range.

8. The display device according to claim 7, wherein
when the detection section detects the third operation, the setting section measures duration of the third operation and performs the selected range setting to increase an area of the portion of the one of the candidate selection ranges that is subjected to the third operation according to the duration of the third operation, the portion being to be set as the selected range.

9. The display device according to claim 7, wherein
the third operation detected by the detection section includes a long press operation.
